(19) United States
(12) Patent Application Publication
(10) Pub. No.: US 2016/0082627 A1
(43) Pub. Date: Mar. 24, 2016

(54) PLASTIC MOULDING METHOD

(71) Applicants: Rafael KILIM, London, Greater London (GB); Simcha KILIM, London, Greater London (GB)

(72) Inventors: Rafael KILIM, London (GB); Simcha KILIM, London (GB)

(21) Appl. No.: 14/891,354

(22) PCT Filed: Apr. 4, 2014
(86) PCT No.: PCT/GB2014/051048

§ 371 Date: Nov. 15, 2015

(30) Foreign Application Priority Data
May 15, 2013 (GB) 1308698.8

(51) Int. Cl. B29C 43/32; B29C 47/44; B29C 67/00; B29C 45/52

(52) U.S. Cl. CPC B29C 43/32; B29C 45/52; B29C 47/44; B29C 67/0055; B29C 2045/528; B29C 2043/325; B33Y 40/00

(57) ABSTRACT

A method of plastic moulding to form a moulded or extruded article, the method employing a moulding apparatus comprising a barrel containing a screw extending between a feed zone supplied by a feed hopper for plastics material, a compression zone and a metering zone for delivery of molten plastics material to a mould or extrusion die, the method comprising introducing into the feed zone a first plastics material (20) and a single body of a second plastics material (22), the first plastics material (20) having a different physical property to the second plastics material and the second plastics material (22) being introduced into the feed zone in a size and a frequency of delivery relative to the flow of the material through the barrel such that the second plastics material (22) is substantially melted and blended with the first plastics material to form a third plastics material with a different physical property to the first or second plastics material across the whole cross sectional area of the metering zone, the molten plastics material delivered to the mould or extrusion die in a predetermined sequence with each plastics material having different physical properties.

### FIELD OF THE INVENTION

This invention relates to a plastic moulding method for forming regions in a moulded or extruded article adjacent to one another but with different physical properties.

### BACKGROUND TO THE INVENTION

Plastics material articles are commonly produced by injection moulding, extrusion or blow moulding which involves propelling plastics material from a screw and barrel assembly into a mould or through a shaping die. The injection and extruder assembly typically comprises a barrel which is gravity fed from a hopper with plastics material feedstock in granular form. A screw-type extruder in the barrel transports the granules along a sequence of sections. Heat is generated by the shearing action of the screw on the material and by heating elements around the barrel, so that the plastics material is molten by the time it reaches the last section. The plastics material is also compressed and degassed. From the last section, the molten material is extruded through a nozzle or injected by advancing the screw plunger.

The primary constituent of the feedstock may be colourless base plastics material. To produce special visual effects in moulded articles, a colourant or other additive may be introduced into the feedstock before or during the melting process. The colourant may be a powder or what is referred to as a masterbatch, which may consist of a carrier of a plastics material, which may be similar to or different from the feedstock material, with a high concentration of colour (pigment) loading.

Certain multi-coloured visual effects in moulded articles, known as variegated effects, consist of regions of concentrated colour, with gradually changing colour zones between each region. To achieve these, it is known to introduce each of a range of multi-colorants into the feedstock in turn and for each colourant to remain confined to the portion of feedstock into which it is introduced, up to the point of melting. However, because granules of masterbatch are intentionally as small as possible so as to achieve a high ratio of masterbatch to feedstock, the masterbatch granules disperse uniformly, which results in indistinct colour regions in moulded articles.

In WO98/23433A we disclosed a modified injection apparatus for controlled delivery of granular materials fed into the barrel of the injector to achieve multi-colour effects in the moulded articles. While this apparatus achieved good results, the additional cost of the precision delivery apparatus was a limiting factor in adoption of the method.

US2004/0038002 discloses an extruded wood imitation component and a process to produce the same. The component has a solid core with streaks of contrasting coloured polymer running throughout to simulate a natural wood appearance. The effect is produced by introducing into the pre-extrusion mix groups of different coloured pellets and pellets of different sizes. Larger pellets take longer to melt, thus receive less mixing. This results in larger and longer streaks of the coloured polymer.

US2011/0177291 discloses a co-extrusion process for making decorative mouldings having a simulated wood appearance. Colour particles are added to the pre-mix in the conventional manner, the colour particles having a different melting point to the base material. The mixture travels within the tubular channel of an extruder and the heat and shear energy imparted to it is not sufficient to completely mix the colour though out the mixture. Coloured helical vein segments are thus retained on the co-extruded component.

There has now been devised a method which overcomes or substantially mitigates the above mentioned and/or other disadvantages associated with the prior art.

### SUMMARY OF THE INVENTION

In a first aspect of the invention there is provided a method of plastic moulding to form a moulded or extruded article, the method employing a moulding apparatus comprising a barrel containing a screw extending between a feed zone supplied by a feed hopper for plastics material, a compression zone and a metering zone for delivery of molten plastics material to a mould or extrusion die, the method comprising introducing into the feed zone a first plastics material and a single body of a second plastics material, the first plastics material having a different physical property to the second plastics material and the second plastics material being introduced into the feed zone in a size and a frequency of delivery relative to the flow of the material through the barrel such that the second plastics material is substantially melted and blended with the first plastics material to form a third plastics material with a different physical property to the first or second plastics material across the whole cross sectional area of the metering zone, the molten plastics material delivered to the mould or extrusion die in a predetermined sequence with each plastics material having different physical properties.

The method according to the invention is advantageous because adding a single body of material requires less machinery and technical set up than adding small amounts of masterbatch (for example). This reduces the overall cost of production. It also makes the control of either random or dosage delivery more accurate, and as a result improves the control in final product repeatability. Furthermore, the size and frequency of the delivery means that the second material completely melts within the barrel of the extruder, without affecting the structural integrity of the extruded or moulded article and the third material across the whole cross sectional area of the metering zone. Thus the resulting moulded or extruded article has adjacent regions of plastics material therein with different physical properties.

The physical property is preferably colour, but may also comprise (without limiting) density, weight, opacity or malleability for example. The different physical properties may arise from incorporation of colourant, filler materials, such as waxes or carrier materials, or additives, into the plastics materials.

The first plastics material can be any plastics material. Preferably the first plastics material is a base polymer material and may be called “capstock” or “feedstock” or the like.

The second plastics material can be any plastics material. Preferably the body of the second plastics material is sized such that the ratio by weight or volume of second plastics material to first plastics material remains intact up to the point of melting. The second plastics material is preferably manufactured by extrusion, injection moulding, compression moulding or 3d printing. Preferably the body of second plastics material is formed from a mixture of plastics material and an additive.

The single body of the second plastics material can take on a number of external forms. The single body of the second plastics material preferably comprises portions which are in the form of a ball, a pill, a cylinder, a tablet or a ribbon. For example the single body of the second plastics material may be ball, pill, cylinder, tablet or ribbon shaped, or the like. Preferably the shape of the single body of the second plastics material is that which is most easily transported by the extruder or most compatible with the extruder. The single body of the second plastics material is preferably equivalent in weight to a cluster of masterbatch granules such that the ratio by weight or volume of colorant to feedstock remains intact up to the point of melting. That way, a concentrated colour region is produced in the melted plastics material. The single body of the second plastics material preferably comprises two or more portions joined together. Each portion may have the same or different physical properties to its neighbour. For example, the single body may be a dumbbell shape, or a cluster of balls. More preferably, the single body of the second plastics material comprises up to 100 portions joined together.

The first, second or third plastics material may comprise a radio frequency identification (RFID) or anti-theft marker element.

The single body of the second plastics material may be premixed with the first plastics material before it is introduced into the feedzone. Preferably the single body of the first plastics material is premixed with the first plastics material by a volumetric or weight batch doser located on the feed hopper or barrel. Preferably the volumetric or weight batch doser is a unit doser adapted to provide individual bodies of the second plastics material. Preferably the volumetric or weight batch doser has a void which allows a single body of the second plastics material to be moved by the doser at a time into the stream of material in the in the area between the hopper and the screw (the so called “throat” of the barrel).

The third plastics material is preferably a mixture of the first and second plastics materials. Due to dispersal of the second plastics material within the first plastics material when it melts in the metering zone the third plastics material may be disposed over a wide area and overlap substantially with the first plastics material in the resultant moulded or extruded article.

A region according to the invention refers to a section of the moulded or extruded article and occupies the exterior and interior of the moulded or extruded article within the section.

The sequence is predetermined by the sequence that the plastics materials are added to the feed zone, the dynamics of the movement of the materials along the barrel of the screw and the dimensions of the screw and its components, for example.

A preferred embodiment of the invention will now be described in greater detail by way of illustration with reference to the accompanying drawings.

### BRIEF DESCRIPTION OF THE DRAWINGS

In the drawings:

FIG. 1 is a cross-sectional diagrammatic view of a screw and barrel for plastic moulding apparatus;

FIG. 2 is a corresponding view showing the conventional plastic process with colour masterbatch pellets being added;

FIG. 3 is the same view illustrating an embodiment of the method of the invention;

FIGS. 4a to 4g show examples of the bodies that can be added to create regions within the moulded articles having different properties; and

FIG. 5 shows examples of an article moulded in accordance with the method of the invention.

### DETAILED DESCRIPTION OF THE ILLUSTRATED EMBODIMENT

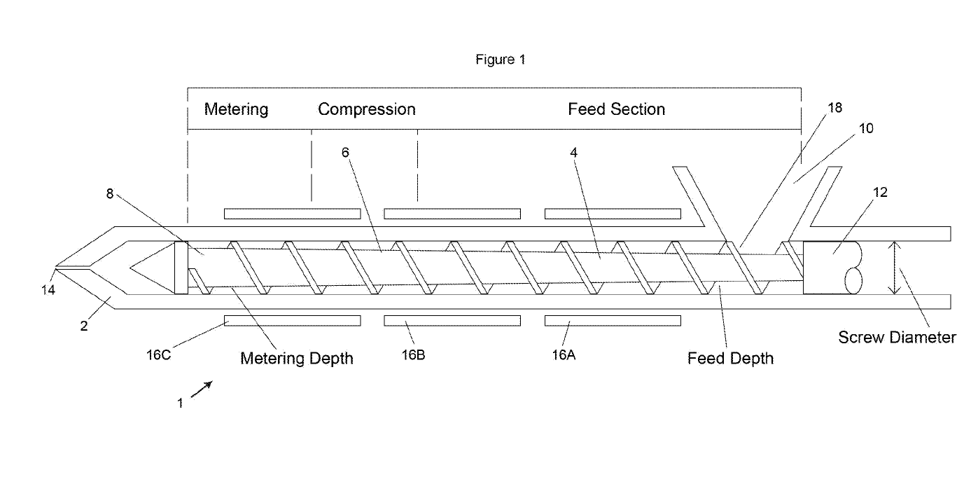

With reference to FIG. 1, a known plastic moulding assembly indicated generally at 1 has a barrel 2 which is divided into a feed section 4, a compression section 6 and a metering section 8. The barrel 2 is gravity fed from a hopper 10 with plastics material at an upstream end of the barrel 2. A screw 12 in the barrel 2 transports the plastics material from the hopper 10 sequentially through the feed section 4, the compression section 6 and the metering section 8 to a nozzle 14 at the downstream end of the barrel 2. Heating elements 16a, 16b, 16c around all three sections 4, 6, 8 of the barrel 2 heat the plastics material as it is transported along, helping it to melt. By the time the plastics material reaches the metering section 8, it is completely melted and mixed. Also, the screw 12 has a core 18 whose diameter gradually increases in the compression section 6 in the direction of travel of the plastics material. As a result, the plastics material is compressed and degassed by the time it reaches the metering section 8, causing an amount of molten plastics material to be ejected from the metering section 8, through the nozzle 14, into a mould or extrusion die (not shown).

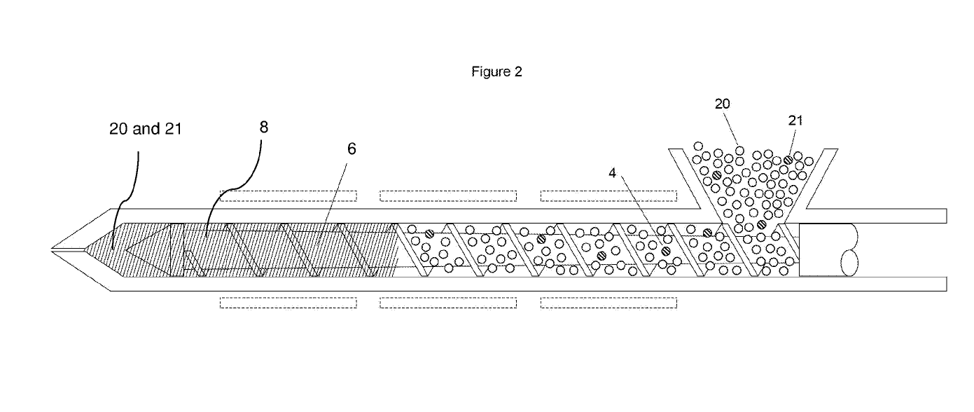

Referring to FIG. 2, conventionally a moulding of uniform composition (colour) is achieved by introducing into the hopper a feedstock of a base plastics granular material 20 into which small pellets of a colour masterbatch material 21 is introduced. The masterbatch 21 consists of a carrier plastics material into which has been blended in the molten state a high concentration of colorant (e.g. a pigment). As the plastics materials are transported through the compression section, the heating elements melt/mix them and the colour masterbatch is gradually blended in so that, by the time the mixture has passed through the compression zone and is in the metering zone it is uniformly blended to achieve the desired colour when injected into the mould or extruded through a die.

To produce multi-coloured visual effects, known as variegated effects, in articles injection moulded or extruded with the assembly 1, the amount of molten plastics material ejected or driven from the nozzle 14 needs to include a region or regions of concentrated colour, with changing colour boundaries between each region.

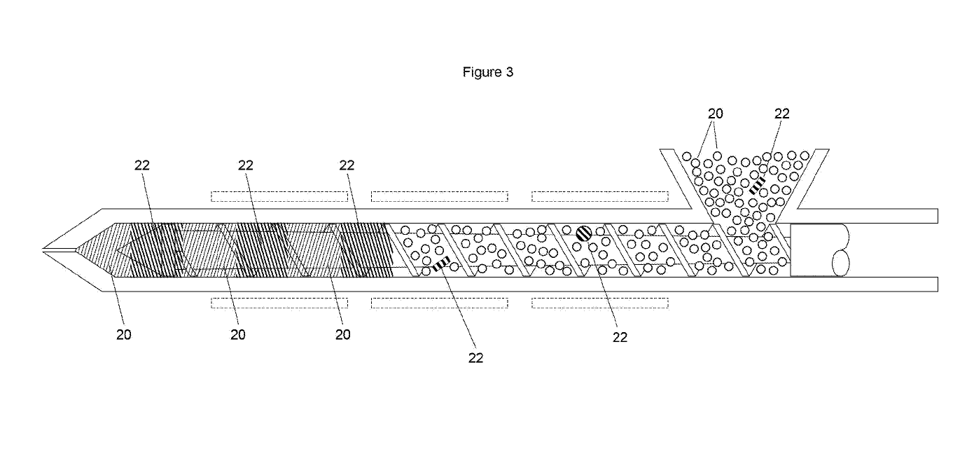

Referring to FIG. 3, the hopper 10 is filled with plastics material feedstock comprising feedstock granules 20. Periodically, a single body 22 of polymer colorant (containing some carrier material) is introduced into the feedstock. The colourant in the body 22 is in a very high concentration, but the ratio of the body 22 to the granules 20 (W:W) is approximately the same as conventional processes. The body 22 remains intact as it travels along the barrel 2, up to the point at which it melts in the metering zone. When the body 2 melts, although there is a certain amount of colour dispersal into the surrounding molten feedstock, it produces a region of concentrated colour in the molten plastics material. The body 22 is sized sufficiently so that colour occupies the whole cross sectional area of the metering zone. The body 22 is thereby blended with the feedstock granules 20 in a molten state. When the next body arrives, it will produce a second region of dispersal. However, there will be an area of reduced colour concentration between the dispersion of the first body and the second body, as they are large in size and separated longitudinally in the cylinder. The longitudinal distance along the barrel between successive bodies 22 does not change significantly until melting/mixing. The size of each region of dispersal is controlled by the size of the body 22 added and the rate at which it travels along the barrel 2. The closeness of each region is controlled by the frequency at which the bodies 22 are added to the feedstock. Various factors are in place to affect the rate of travel and these include changing the speed of rotation of the screw 12 in the barrel 2, or the inclusion of different carrier materials in the body 22.

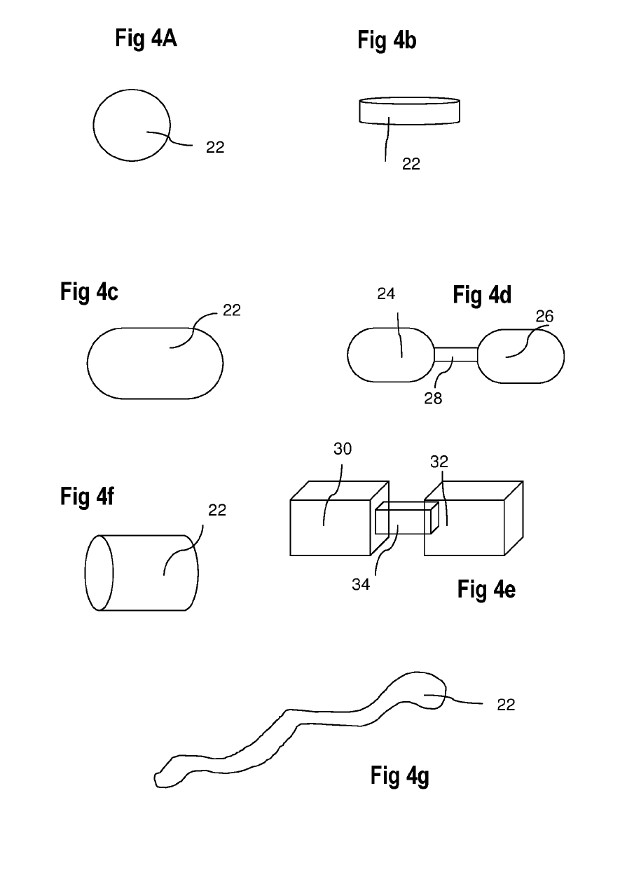

The body 22 can take a number of different forms. The common characteristic of each form is that it has to be equivalent to a cluster of masterbatch granules such that the ratio by weight or volume of colorant to feedstock remains intact up to the point of melting. That way, a concentrated colour region is produced in the melted plastics material. For example, the body 22 can be in the form of a ball (FIG. 4a, plan view), a pill (FIG. 4c, plan view), a cylinder (FIG. 4f, 3d view), a tablet (FIG. 4b, 3d view) or a ribbon (FIG. 4g, plan view). A number of shapes of body 22 are feasible; those that are most easily transported by the extruder 12 or of a shape that is most compatible with the extruder 12 tend to be preferred.

In one particular embodiment, as shown in FIG. 4d (plan view), the body 22 comprises two parts 24, 26, each in the shape of a pill, joined by a short, cylindrical stem 28. Each of the parts 24, 26 comprises a different colourant so as to produce closely adjacent regions of different colour in a moulded article.

In another particular embodiment, as shown in FIG. 4e (3d view), the body 22 comprises two parts, 30, 32, each in a shape of a rectangular block, joined by a short, rectangular stem 34. The first part 30 comprises a colorant. The second part 32 comprises another additive. The third part 34 comprises a radio frequency identification (RFID) or anti-theft marker element which is moulded into an article.

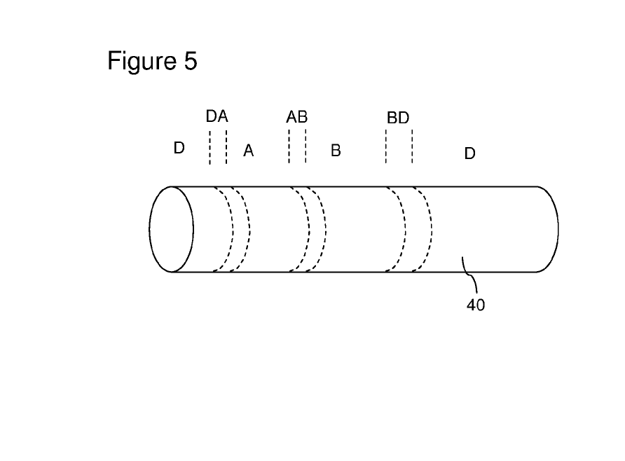

FIG. 5 shows a cylindrical rod 40 extruded in accordance with the method of the invention. The rod 40 has regions A and B with a high concentration of colour A and colour B respectively. Regions D represent the base colour of the plastics material or a fourth colour D. Intermediate regions DA, AB, BD are between each main region. In the intermediate regions there will be some graduation of colour resulting from blending.

1. A method of plastic moulding to form a moulded or extruded article, the method employing a moulding apparatus comprising a barrel containing a screw extending between a feed zone supplied by a feed hopper for plastics material, a compression zone and a metering zone for delivery of molten plastics material to a mould or extrusion die, the method comprising introducing into the feed zone a first plastics material and a single body of a second plastics material, the first plastics material having a different physical property to the second plastics material and the second plastics material being introduced into the feed zone in a size and a frequency of delivery relative to the flow of the material through the barrel such that the second plastics material is substantially melted and blended with the first plastics material to form a third plastics material with a different physical property to the first or second plastics material across the whole cross sectional area of the metering zone, the molten plastics material delivered to the mould or extrusion die in a predetermined sequence with each plastics material having different physical properties.

2. A method according to claim 1, wherein the physical property is colour.

3. A method according to claim 1, wherein the different physical properties result from incorporation of colourant, filler materials, such as waxes or carrier materials, or additives into the plastics materials.

4. A method according to claim 1, wherein the body of the second plastics material is sized such that the ratio by weight or volume of second plastics material to first plastics material remains intact up to the point of melting.

5. A method according to claim 1, wherein the second plastics material is manufactured by extrusion, injection moulding, compression moulding or 3d printing.

6. A method according to claim 1, wherein the body of the second plastics material comprises portions which are in the form of a ball, a pill, a cylinder, a tablet or a ribbon.

7. A method according to claim 1, wherein the first, second or third plastics material comprises a radio frequency identification (RFID) or anti-theft marker element.

8. A method according to claim 1, wherein the single body of the second plastics material comprises two or more portions joined together.

9. A method according to claim 8, wherein each portion has the same or different physical properties to its neighbour.

10. A method according to claim 1, wherein the bodies are formed from a mixture of plastics material and an additive.

11. (canceled)
